(19) United States
(12) Patent Application Publication
(10) Pub. No.: US 2012/0292218 A1
(43) Pub. Date: Nov. 22, 2012

(54) SHRINK SLEEVE LABELED EPS FOAM CONTAINER

(75) Inventor: William Lloyd Prickett, JR., Buford, GA (US)

(73) Assignee: New Wincup Holdings, Inc., Stone Mountain, GA (US)

(21) Appl. No.: 13/475,609

(22) Filed: May 18, 2012

Related U.S. Application Data
(60) Provisional application No. 61/487,459, filed on May 18, 2011.

(51) Int. Cl. B65D 85/00; B32B 37/14

(52) U.S. Cl. 206/459.5; 156/85; 156/556

(57) ABSTRACT

A food or beverage container may include an open-ended expanded polystyrene (EPS) foam body and a shrink sleeve film label. The shrink sleeve film label may be made of a material which may enable a high quality design to be displayed on the outside of the EPS foam body. A heating source may be applied to the shrink sleeve film label to fit the label to the EPS foam body. The shrink sleeve film label may be affixed to the EPS foam body using an adhesive. The EPS foam body, the shrink sleeve film label, and/or the adhesive may comprise compostable or recyclable materials, such that the entire food or beverage container may be compostable or recyclable.

### CROSS-REFERENCE TO RELATED APPLICATIONS

This application claims the benefit of provisional application No. 61/487,459, filed May 18, 2011, the entirety of which is incorporated by reference herein.

### BACKGROUND

Disposable containers, such as food and beverage containers, for example, may be made of paperboard, polypropylene, or expanded polystyrene (EPS) foam. Paperboard may be desirable for a number of reasons. For example, paperboard may provide a high-quality printable surface from the lip of the cup to its base. Paperboard, however, may be a poor insulator of heat. A paperboard cup containing a hot beverage, for example, may be difficult to hold. To compensate for the lack of insulation provided by a single paperboard cup, a plurality of such cups may be nested together. A separate cardboard sleeve may also be used to provide insulation, or the cup may include handles.

EPS foam containers typically provide better thermal insulation than do paperboard containers. Accordingly, EPS foam containers tend to be more suitable than paperboard containers for containing hot or cold food or beverages, at least in terms of thermal insulation. The thermal insulating properties of EPS foam also prevent heat transfer to the user, which provides for safety of use. When used with cold drinks, for example, the insulating properties prevent condensation, which may be perceived as sweating or even leakage from the container.

The exterior surface of an EPS foam container, however, may not provide for high-quality printing. Techniques are used for improving the appearance of EPS foam containers by wrapping paper around the EPS foam body of the container. There is a need, however, for continued improvement in the appearance of EPS foam containers to make them more attractive to end users, and/or to provide for advertising on the container. There is also a need for disposable, preferably fully recyclable, EPS foam containers that have high-quality printing on all or part of the exterior surface of the container.

### SUMMARY

Embodiments are described herein for a food or beverage container that includes an open-ended expanded polystyrene (EPS) foam body and a shrink sleeve film label. The shrink sleeve film label may envelope at least one portion of the exterior surface of the open-ended EPS foam body. The shrink sleeve film label may enable the display of a high quality design on the exterior surface of the EPS foam body and may be comprised of a material capable of fitting a form of the open-ended EPS foam body upon an application of heat. The shrink sleeve film label may be affixed to the exterior of the EPS foam body using an adhesive, such as a thermal adhesive for example. The EPS foam body, the shrink sleeve film label, and/or the adhesive may comprise compostable or recyclable materials, such that the entire food or beverage container may be compostable and/or recyclable.

System, method, and apparatus embodiments are described herein for manufacturing a shrink sleeve labeled EPS container. According to an example embodiment, a container may be received that has an open-ended EPS foam body and a shrink sleeve film label may be applied to at least one pre-defined portion of the exterior surface of the EPS container. The EPS container may be provided via a container dispenser and the shrink sleeve film label may be applied using a sleeve dispenser.

### BRIEF DESCRIPTION OF THE DRAWINGS

FIGS. 1A-1C provide example embodiments of shrink sleeve labeled expanded polystyrene (EPS) foam containers.

FIGS. 2A-2C provide partial cutaway views of example embodiments of EPS car cups which are suitable for shrink sleeve labeling.

FIGS. 3A-3F provide partial cutaway views of example embodiments of straight-walled EPS cups which are suitable for shrink sleeve labeling.

FIGS. 4A-4C provide cross-sectional views of example embodiments of EPS food containers that are suitable for shrink sleeve labeling.

FIG. 5 depicts an example apparatus and process for manufacturing a shrink sleeve labeled EPS container.

### DETAILED DESCRIPTION

Embodiments are described herein for food and/or beverage containers having an expanded polystyrene (EPS) foam body, or a body comprising similar insulating properties, while also providing high quality printing on the exterior surface of the container. For example, the body of the container may be an EPS foam body that may be fully, or at least partially, enveloped by a shrink sleeve film covering. The EPS foam body may provide thermal insulation and may be useful in containing food products, or hot or cold beverages, for example, in a manner that is comfortable to a user. The shrink sleeve film may comprise a material capable of fitting the form of any EPS container by the application of heat to the shrink sleeve film. The shrink sleeve film covering may provide for high quality printing on an exterior surface of the container.

According to an example embodiment, the shrink sleeve film covering may be used for advertisement on the exterior of the EPS container. The shrink wrap sleeve label may be clear or colored with any desirable design, lettering, symbols, or other visible design for example. The layout of the design may be chosen such that, after the label is shrunk onto the container, the resultant design is not distorted. The placement of the design on the shrink sleeve film label may be chosen such that, after the label is shrunk onto the container, the design resides within a predefined area on the EPS container.

The shrink sleeve film may include a temperature sensitive indicator, which may indicate to the user a relative temperature of the exterior surface of the container. For example, the shrink sleeve may indicate whether the exterior of the container is hot or cold by using one or more color-coded indicators corresponding to the relative exterior temperature of the container. Compostable, recyclable, or non-recyclable materials may be selected for the EPS foam and/or the shrink sleeve film. Thus, the entire container may be recyclable, compostable, or a combination of both.

A number of shrink sleeve labeled EPS foam containers are disclosed herein. Each such container may have an EPS foam body having an exterior that is partially or totally enveloped in a shrink sleeve film label. The shrink sleeve film label may be a sleeve of material that may be cut at the appropriate lengths to fit any EPS foam container. The shrink sleeve film material may be fit over the EPS foam container and heated, causing the sleeve to shrink to the desired location on the container. The shrink sleeve labeled EPS foam container may provide thermal insulation while simultaneously providing for the display of high quality printed matter, which may be attractive to a user of the container for example. The shrink sleeve label causes greater side-wall deflection than in an unwrapped container, which may enable greater insulation for items (e.g., food and/or beverages) held within the container.

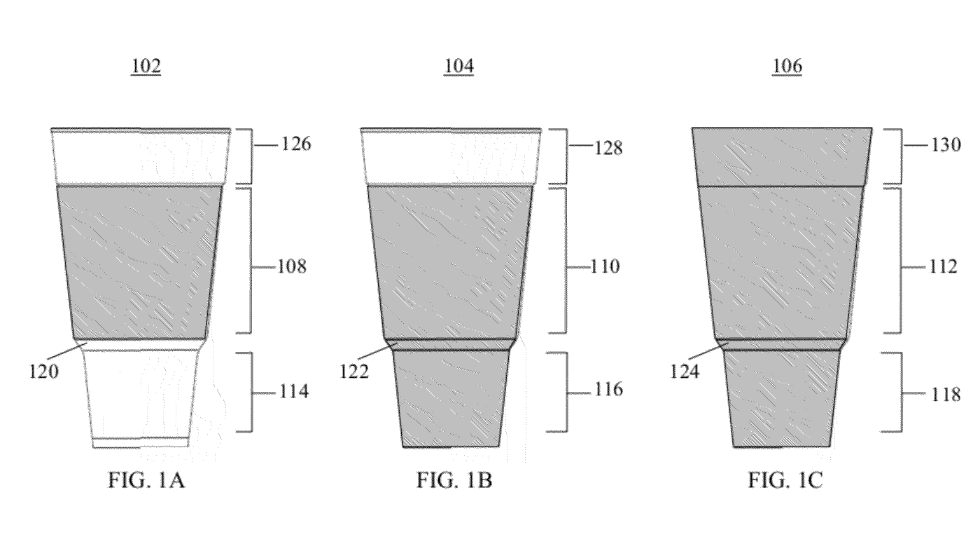

FIGS. 1A-1C provide example embodiments of shrink sleeve labeled EPS foam containers 102, 104, 106, respectively. Each of the containers 102, 104, 106 has a larger upper side wall 108, 110, 112, a transitional portion 120, 122, 124, and a smaller lower side wall 114, 116, 118, respectively. Such a configuration may be referred to as a “car cup.” While the EPS foam containers in FIGS. 1A-1C illustrate a car cup, the shrink sleeve labeled EPS foam containers described herein are not limited to such an embodiment, but may include any type of EPS foam food and/or beverage container.

Each of the containers 102, 104, 106 has an upper side wall 108, 110, 112, a lower side wall 114, 116, 118, and a transitional portion 120, 122, 124 extending between the upper side wall 108, 110, 112 and the lower side wall 114, 116, 118, respectively. The diameter of each of the containers 102, 104, 106 (transverse to its longitudinal axis) is greater in the upper side wall 108, 110, 112 than it is in the lower side wall 114, 116, 118. The transitional portions 120, 122, 124 may be curved, flared, or straight. Each container 102, 104, 106 includes a rim collar 126, 128, 130 that extends from the top of the upper side wall 108, 110, 112, respectively, to the top rim of the cup. Each container 102, 104, 106 may include a bottom portion (not shown in FIGS. 1A-1C) that extends to the bottom rim of the container 102, 104, 106.

The container configurations depicted in FIGS. 1A-1C, and described elsewhere herein, are merely provided as examples. Numerous container configurations are known, and any configuration may be employed in the embodiments described herein. For example, the cups shown in FIGS. 1A-1C may be 20 ounce cups, while other standard (e.g., 3.5-64 ounce cups, such as 8, 12, 16, or 32 ounce cups) or non-standard cup sizes may be employed. Techniques for manufacturing an EPS cup or other similar containers are well known, and need not be described herein. It should be understood that other EPS containers, such as food containers for example, may be shrink sleeve labeled as described herein.

Any portion, or the entirety, of the exterior of each container 102, 104, 106 may be enveloped by a shrink sleeve film. As shown in FIG. 1A, the sleeve may extend between the lower edge of the rim collar 126 and the transitional portion 120. As shown in FIG. 1B, the sleeve may extend from the lower edge of the rim collar 128 to the bottom of the container 104. As shown in FIG. 1C, the sleeve may extend from the top of the rim collar 130 to the bottom of the container 106. The sleeve may also envelope all or part of the bottom of the container (not shown).

In any of the embodiments described herein, an adhesive may be used to affix the shrink sleeve label to the exterior of the container and/or to itself. According to an example embodiment, the adhesive may be a thermal adhesive, which may enable the shrink sleeve label to be affixed to the container upon the application of heat for example. The adhesive may be colorless or it may be a color adhesive, such that it matches the color and/or design on the shrink sleeve film label for example. The adhesive may also be made of a compostable and/or recyclable material, such that the entire shrink sleeve film labeled container may be compostable and/or recyclable for example.

In some embodiments, an adhesive may not be implemented for affixing the shrink sleeve label to the container. For example, in the embodiment depicted in FIG. 1C, an adhesive may not be used in some implementations, as the shrink wrap may shrink onto the top and bottom rims of the container 106, such that the label is affixed to the container 106 as it shrinks via the application of heat during the manufacturing process. As the embodiments depicted in FIGS. 1A and 1B do not extend the shrink sleeve film to the top rim of the rim collars 126, 128 of the containers 102, 104, an adhesive may be used for the label to be properly affixed to the containers 126, 128.

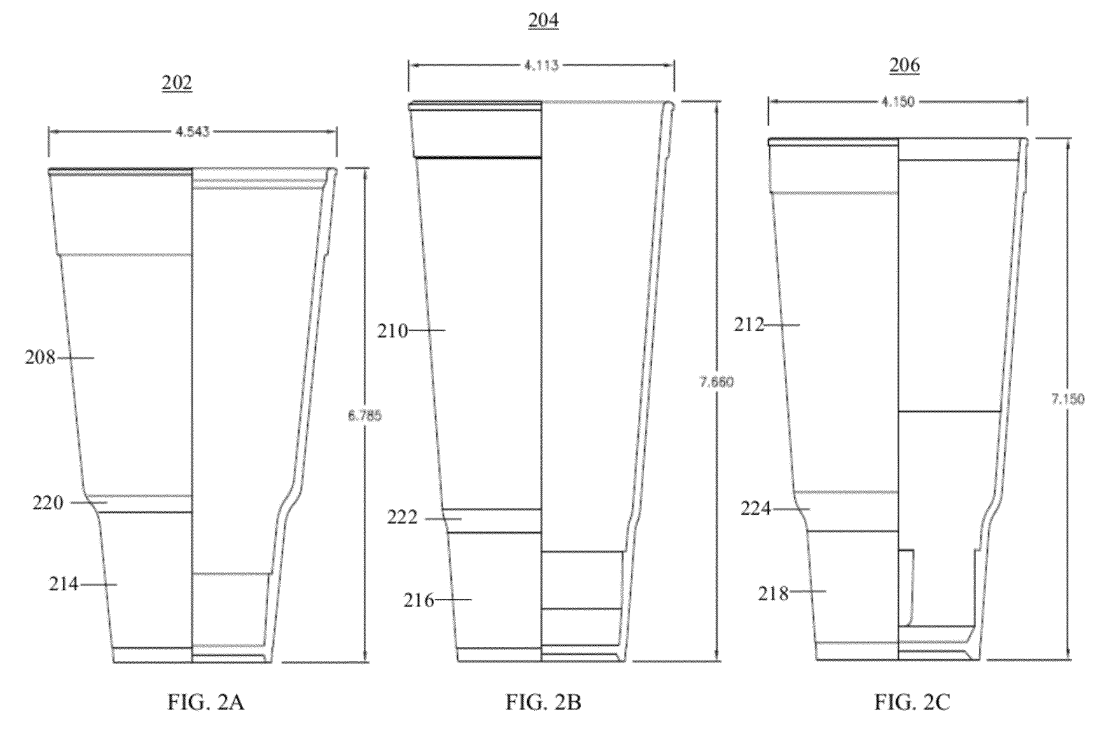

FIGS. 2A-2C provide partial cutaway views of example embodiments of EPS car cups 202, 204, 206 which are suitable for shrink sleeve labeling. As shown in FIGS. 2A-2C, the shrink sleeve label may fit on various forms of car cups having a number of different dimensions. For example, as illustrated in FIGS. 2A-2C, the height of the EPS car cups 202, 204, 206 may range from 6.785-7.660 inches and the diameter at the top of the EPS car cups 202, 204, 206 may range from 4.113-4.543 inches. Similarly, other portions of the EPS car cups 202, 204, 206 may include different dimensions which may be considered for shrink sleeve labeling. For example, EPS car cups 202, 204, 206 may include upper side walls 208, 210, 212, lower side walls 214, 216, 218, and transitional portions 220, 222, 224, respectively. The upper side walls 208, 210, 212, the lower side walls 214, 216, 218, and the transitional portions 220, 222, 224 may each have different dimensions. While FIGS. 2A-2C illustrate particular dimensions of EPS car cups that may be suitable for shrink sleeve labeling, the dimensions of an EPS container suitable for shrink sleeve labeling are not limited as such.

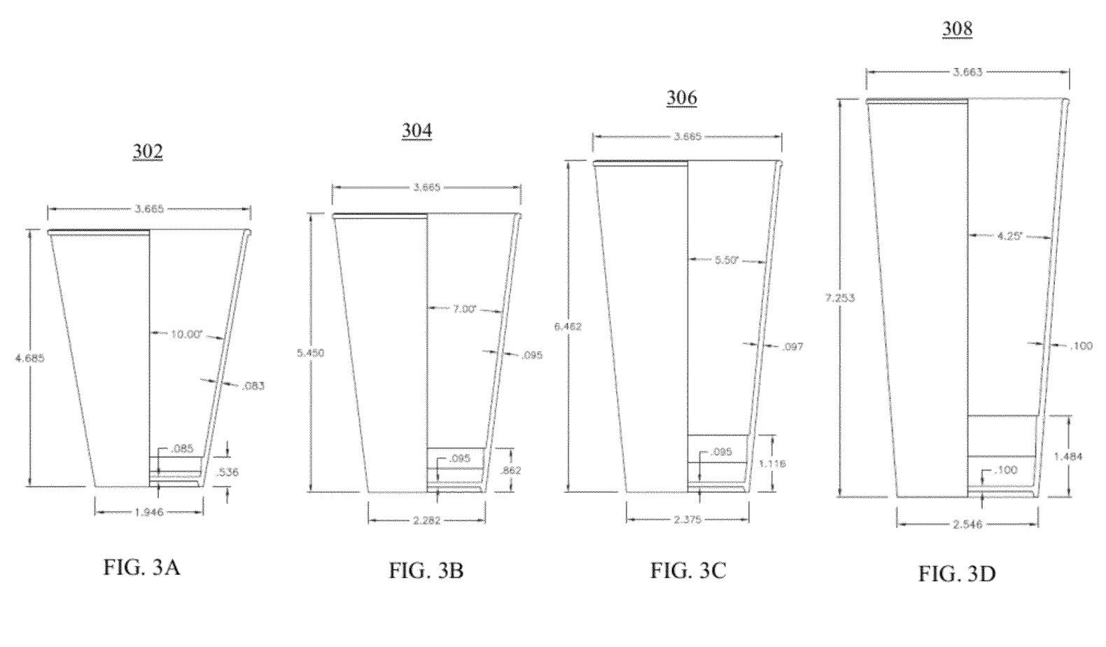

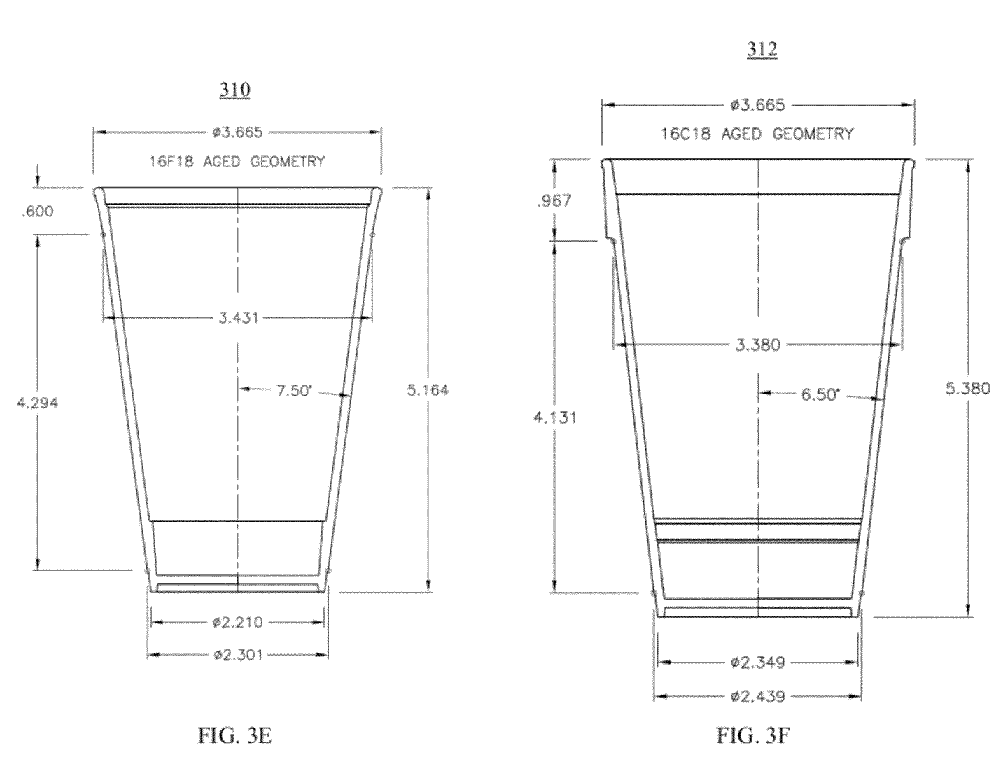

FIGS. 3A-3F provide partial cutaway views of example embodiments of straight-walled EPS cups which are suitable for shrink sleeve labeling. FIGS. 3A-3D illustrate a 12-ounce straight-walled EPS cup 302, 16-ounce straight-walled EPS cup 304, 20-ounce straight-walled EPS cup 306, and 24-ounce straight-walled EPS cup 308, respectively, which may each comprise different dimensions suitable for shrink sleeve labeling. FIGS. 3E and 3F show additional embodiments of straight-walled EPS cups 310 and 312 having a rim collar, which may also be considered for shrink sleeve labeling.

As shown in FIGS. 3A-3F, the straight-walled EPS cups 302, 304, 306, 308, 310, 312 may comprise a height ranging from 4.685-7.253 inches; a diameter at the top ranging from 3.663-3.665 inches; a diameter at the bottom ranging from 1.946-2.546 inches; a thickness at the sides ranging from 0.083-0.100 inches (not shown in FIGS. 3E or 3F); a thickness at the bottom ranging from 0.085-0.100 inches (not shown in FIGS. 3E or 3F); a height of a bottom portion of the container ranging from 0.536-1.484 inches (not shown in FIGS. 3E or 3F); and/or an angle of the side wall of the cup ranging from 4.25-10.00 degrees. FIGS. 3E and 3F further illustrate straight-walled EPS cups 310 and 312 having a rim collar with a height ranging from 0.600-0.967 inches; a side wall with a height ranging from 4.131-4.294 inches; a diameter at the bottom of the side wall ranging from 2.301-2.439 inches; a diameter at the bottom of the container ranging from 2.210-2.349 inches; and a diameter where the sidewall meets the rim collar ranging from 3.431-3.380 inches. While FIGS. 3A-3F illustrate particular dimensions of straight-walled EPS cups that may be suitable for shrink sleeve labeling, the dimensions of an EPS container suitable for shrink sleeve labeling are not limited as such.

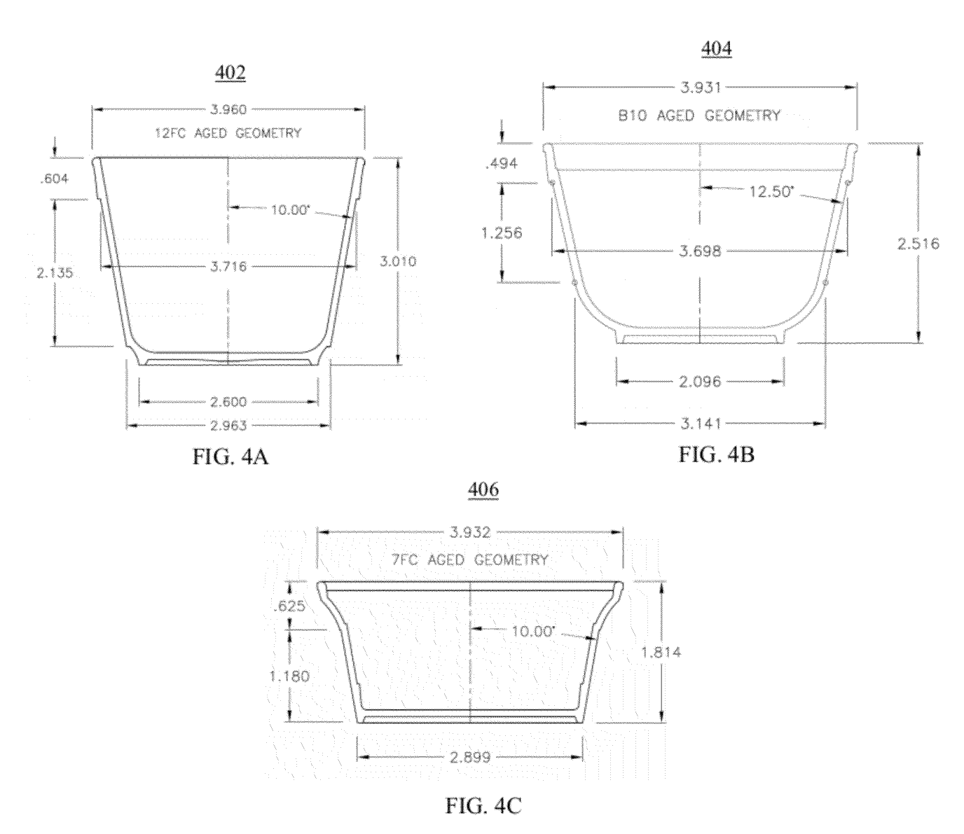

FIGS. 4A-4C provide cross-sectional views of example embodiments of food containers 402, 404, 406 that are suitable for shrink sleeve labeling. As illustrated in FIGS. 4A-4C, respectively, the shrink sleeve label may conform to different forms of food containers, such as straight-walled EPS container 402, rounded EPS container 404 having a rounded exterior body, and/or concave EPS container 406 having a concave exterior body for example. Each of the containers 402, 404, 406 may be comprised of different dimensions and may be enveloped, at least partially, by a shrink sleeve film as described herein. As shown in FIGS. 4A-4C, the EPS containers 402, 404, 406 may comprise a height ranging from 1.814-3.010 inches; a rim collar ranging from 0.494-0.625 inches; a side wall ranging from 1.180-2.135 inches; a diameter at the top ranging from 3.931-3.960 inches; a diameter where the side wall meets the rim collar ranging from 3.698-3.716 inches (not shown in FIG. 4C); a diameter at the bottom of the side wall ranging from 2.899-3.141 inches; a diameter at the bottom ranging from 2.096-2.899 inches; and/or an angle of the side wall ranging from 10.00-12.50 degrees. While FIGS. 4A-4C illustrate particular dimensions of EPS food containers that may be suitable for shrink sleeve labeling, the dimensions of an EPS container suitable for shrink sleeve labeling are not limited as such.

Embodiments are described herein for making or manufacturing a shrink sleeve labeled EPS foam container. For example, the shrink sleeve labeled EPS foam container may be made by providing an EPS foam container body, enveloping the container body in a shrink sleeve film material, and activating shrinking characteristics of the shrink sleeve (e.g., by the application of heat) to cause the shrink sleeve to conform to the exterior of the EPS container body.

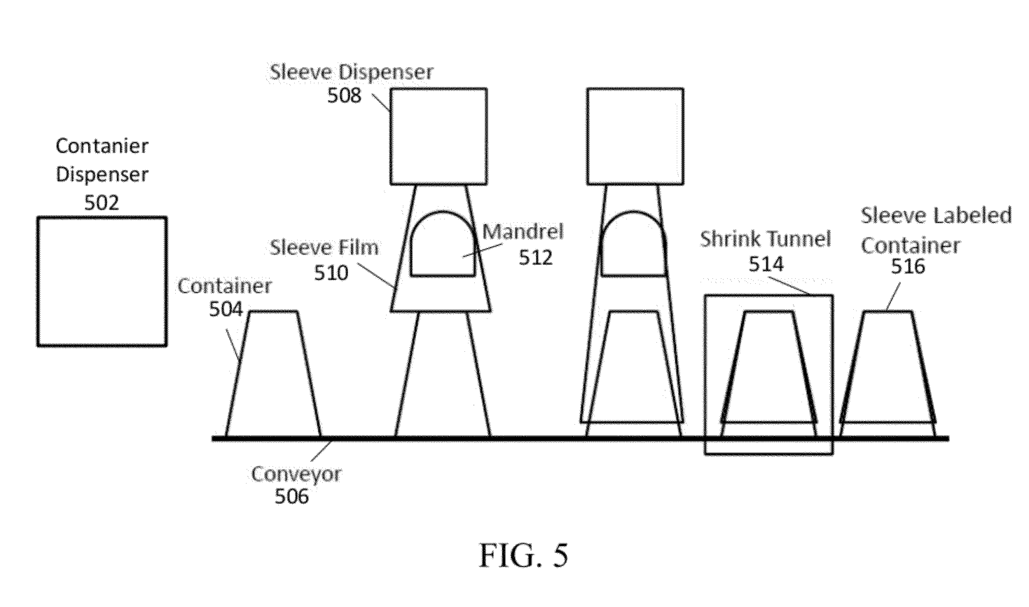

FIG. 5 depicts an example apparatus and process for manufacturing shrink sleeve labeled EPS foam containers. The shrink sleeve labeled EPS foam container 516 may be manufactured from a container 504 and a sleeve film 510 using a conveyor 506, a shrink sleeve label applicator or dispenser 508, a mandrel 512, and/or a shrink tunnel 514. As shown in FIG. 5, one or more manufactured EPS foam containers, such as EPS foam container 504 for example, may be dispensed (e.g., one at a time) onto a conveyor 506. According to an example embodiment, the EPS container 504 may be fed into an automatic container dispenser 502, such as a hopper for example, that enables the container to be properly placed on the conveyor 506. The container 504 may be placed onto the conveyor 506 upside down (e.g., bottom side up). Any mechanical means may be used to stabilize the container 504 on the conveyor so that they may be conveyed below a shrink sleeve label applicator or dispenser 508. As the container 504 may be made of a light-weight EPS foam or other lightweight material, the container 504 may be held in place while on the conveyor 506 and/or during application of the shrink sleeve film 510. For example, the container 504 may ride on a puck or vacuum implemented by the conveyor 506. According to an example embodiment, the puck or vacuum may be specific to the dimensions of the container 504.

In essence, the shrink sleeve film label 510 may be provided as a roll of tubular or shoulder formed film. The shrink sleeve film label 510 may be prepared with any desired coloring, design, lettering, etc. For example, shrink sleeve film label 510 may be prepared with a high-resolution advertisement. As the container 504 passes below the shrink sleeve applicator 508, the shrink sleeve roll may be unfurled over a bullet mandrel 512, such that the bullet mandrel 512 causes the shrink sleeve film label 510 to open into its cylindrical shape. The opened shrink sleeve film label 510 may be carried down to a desired or pre-configured point on the container 504. For example, the leading edge of the shrink sleeve may be carried all the way down to the upper rim of the container 504 (e.g., as depicted in FIG. 1C), or to the edge of the rim collar (e.g., as depicted in FIGS. 1A and 1B).

The shrink sleeve film label 510 may be cut from the roll by the sleeve dispenser 508 at the appropriate point, so that when the leading edge of the sleeve is carried down to the desired point of the container 504 and/or the trailing edge of the shrink sleeve film label 510 ends up at the appropriate location along the edge of the container 504 (e.g., at the transition portion, as depicted in FIG. 1A, or at the bottom of the container, as depicted in FIGS. 1A and 1B). The sleeve dispenser may be configured to affix the shrink sleeve film label to the exterior surface of the EPS container using a thermal adhesive that may be activated upon application of heat for example.

After the shrink sleeve film label 510 is applied to the container 504, the container 504 may be conveyed through a shrink tunnel 514, such as a heat source for example, which may cause the shrink sleeve film label 510 to activate its shrinking properties and shrink onto the exterior of the container 504. The heat source may comprise an electric heat or steam heat for example. Any design on the shrink sleeve film label 510 may be located such that it ends up in a pre-defined area on the container 504 after the shrinking of the shrink sleeve film label 510.

In an embodiment, where the shrink sleeve film label 510 extends to the top and/or bottom rim of the container 504, the heating process may cause the shrink sleeve film label 510 to cling to the rim(s) of the container 504. Where the shrink sleeve film label 510 does not extend from rim-to-rim, or even when the shrink sleeve film label 510 does extend from rim-to-rim, an adhesive may be used to affix the shrink sleeve film label 510 to the exterior surface of the container 504. In an example embodiment, the adhesive may be applied in beads or lines to the side of the container 504 before the shrink sleeve film label 510 is applied, or the shrink sleeve film label 510 itself may be provided with adhesive already applied to the inner surface of the film (e.g., the surface that will be applied to the exterior surface of the container 504). If a thermal adhesive is used, the adhesive may be activated as the container 504 passes through the heat source.

The finished container 516 may comprise the container 504 and the shrink sleeve film label 510 attached to the container 504 at the desired or pre-configured point. The finished container 516 may be conveyed away to cool and/or to be stacked for final packaging and shipment. The shrinking process may allow for wrapping “fresh” containers by accelerating pentane off-gassing, which may cause the container 504 to achieve its normally aged dimensions and allow for wrapping the container 504 “inline.” The final sleeve labeled container 516 may have improved rigidity characteristics as compared to those of the container 504 prior to labeling, which may enable for better a better grip on the final sleeve labeled container 516.

The described embodiments are provided as examples and are not meant as limitations. For example, while the food or beverage containers described herein may be referred to as EPS containers, the containers may be made of EPS, polyethylene terephalate (PET), polylactic acid (PLA), and/or another disposable material having similar insulation properties. Additionally, while certain features or elements are described in particular combinations herein, each feature or element may be used alone or in other various combinations.

What is claimed:

1. A food or beverage container comprising:
an open-ended expanded polystyrene (EPS) foam body; and
a shrink sleeve film label enveloping at least one portion of an exterior surface of the open-ended EPS foam body.

2. The food or beverage container of claim 1, wherein the shrink sleeve film label enables a display of a high quality design on the exterior surface of the EPS foam body.

3. The food or beverage container of claim 1, wherein the shrink sleeve film label comprises a material capable of fitting a form of the open-ended EPS foam body upon an application of heat to the shrink sleeve film label.

4. The food or beverage container of claim 3, wherein the shrink sleeve film label comprises a design configured to occupy a pre-defined area of the exterior surface of the open-ended EPS foam body after the application of the heat to the shrink sleeve film label.

5. The food or beverage container of claim 1, further comprising an adhesive that affixes the shrink sleeve film label to the exterior surface of the open-ended EPS foam body, and wherein the open-ended EPS foam body, the shrink sleeve film label, and the adhesive comprise compostable or recyclable materials.

6. The food or beverage container of claim 1, wherein the shrink sleeve film label comprises a polystyrene material.

7. The food or beverage container of claim 1, wherein the shrink sleeve film label comprises a portion of a shrink sleeve roll of film.

8. A method for manufacturing a shrink sleeve labeled expanded polystyrene (EPS) container, the method comprising:
receiving a container having an open-ended EPS foam body; and
applying a shrink sleeve film label to at least one pre-defined portion of an exterior surface of the EPS container.

9. The method of claim 8, wherein the shrink sleeve film label enables a display of a high quality design on the exterior surface of the EPS container.

10. The method of claim 8, wherein applying the shrink sleeve film label further comprises heating the shrink sleeve film label to fit the shrink sleeve film label to the exterior surface of the EPS container at the at least one pre-defined portion.

11. The method of claim 10, further comprising cutting the shrink sleeve film label from a shrink sleeve roll of film such that the shrink sleeve film label will fit the exterior surface of the EPS container at the at least one portion after said heating.

12. The method of claim 10, wherein applying the shrink sleeve film label further comprises affixing the shrink sleeve film label to the exterior surface of the EPS container using a thermal adhesive that is activated upon said heating.

13. The method of claim 12, wherein the EPS container, the shrink sleeve film label, and the adhesive comprise compostable or recyclable materials.

14. The method of claim 8, further comprising stabilizing the EPS container via at least one of a puck or a vacuum while the shrink sleeve film label is being applied.

15. An apparatus for manufacturing a shrink sleeve labeled expanded polystyrene (EPS) container, the apparatus comprising:
a container dispenser configured to provide a container having an open-ended EPS foam body; and
a sleeve dispenser configured to apply a shrink sleeve film label to at least one pre-defined portion of an exterior surface of the EPS container.

16. The apparatus of claim 15, wherein the apparatus further comprises a shrink tunnel configured to activate shrinking properties associated with the shrink sleeve film label such that the shrink sleeve film label fits the exterior surface of the EPS container at the at least one pre-defined portion.

17. The apparatus of claim 16, wherein the shrink tunnel is further configured to activate the shrinking properties via an application of a heat source.

18. The apparatus of claim 17, wherein the sleeve dispenser is further configured to cut the shrink sleeve film label from a shrink sleeve roll of film such that the shrink sleeve film label will fit the exterior surface of the EPS container at the at least one portion after the application of the heat source.

19. The apparatus of claim 17, wherein the sleeve dispenser is further configured to affix the shrink sleeve film label to the exterior surface of the EPS container using a thermal adhesive that is activated upon said heating.

20. The apparatus of claim 17, further comprising a conveyor configured to stabilize the EPS container while the sleeve dispenser is applying the shrink sleeve film label.
